(19) United States
(12) Patent Application Publication
(10) Pub. No.: US 2014/0358742 A1
(43) Pub. Date: Dec. 4, 2014

(54) Systems And Methods For Mapping In-Store Transactions To Customer Profiles

(71) Applicant: Wal-Mart Stores, Inc., Bentonville, AR (US)

(72) Inventors: Kannan Achan, Mountain View, CA (US); Afroza Ali, Sunnyvale, CA (US); Ron Benson, San Francisco, CA (US)

(21) Appl. No.: 13/907,533

(22) Filed: May 31, 2013

(51) Int. Cl. G06Q 40/00

(52) U.S. Cl. CPC G06Q 40/12
USPC 705/30

(57) ABSTRACT

Example systems and methods for mapping in-store transactions to customer profiles are described. In one implementation, a method receives information of a plurality of customer profiles of a plurality of online customers. Each of the customer profiles includes a plurality of types of attributes associated with a respective one of the online customers. The types of attributes include a first type of attribute. The method also receives information of a plurality of in-store transactions by a plurality of in-store customers. The information of each of the in-store transactions includes the first type of attribute associated with the respective in-store customer. The method further maps, for at least one of the in-store customers, one or more of the customer profiles of online customers to the at least one of the in-store customers based at least in part on the first type of attribute.

### TECHNICAL FIELD

The present disclosure relates to electronic commerce and, in particular, to systems and methods for mapping in-store transactions to existing customer profiles.

### BACKGROUND

Electronic commerce, commonly known as e-commerce, has become a popular way of shopping for many in recent years. Given the growing trend of online shopping by consumers around the world, many brick-and-mortar businesses are beginning to or have begun to operate e-commerce websites as a new sales channel as well as a new source of revenue stream. In other cases, brick-and-mortar business may be affiliated with online businesses that operate e-commerce websites, and vice versa. For a business that operates one or more physical retail stores and an e-commerce website, it is not uncommon that some of its customers shop not only in the physical stores but also online on the e-commerce website operated by the business as an e-commerce merchant. When an e-commerce customer, or online customer, conducts transactions such as purchase of goods on an e-commerce website operated by an e-commerce merchant, the e-commerce merchant generally will establish and maintain a customer profile for the online customer. A customer profile typically includes the first name, last name and mailing (physical) address, and may also include additional personal information related to the respective online customer, e.g., phone number, e-mail address, credit card information, etc.

From the perspective of a business that operates one or more physical retail stores as well as an e-commerce website, it would be ideal to map in-store transactions to existing, valid customer profiles. In an example scenario, customer A buys a large flat-screen TV at a retail store operated by business B and swipes a credit card to complete the transaction, and customer A later logs into the e-commerce website operated by business B. For business B, applications of such information are plenty if a unique identification pertaining to the credit card used in-store by customer A could be mapped or matched to a customer profile in a database of valid customer profiles maintained by business B. For example, recommendations could be precisely targeted based on in-store purchases, customer A could be enticed to share a review of the flat-screen TV, and business B could learn what customers who recently purchased a TV may be interested in purchasing next, and so on.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an example framework in accordance with the present disclosure.

FIGS. 2-5B are diagrams depicting example implementations of an algorithm in systems and methods in accordance with the present disclosure.

FIG. 6 is a block diagram depicting an embodiment of a computing device configured to implement systems and methods in accordance with the present disclosure.

FIG. 7 is a flowchart diagram of an embodiment of a process in accordance with the present disclosure.

FIG. 8 is a flowchart diagram of another embodiment of a process in accordance with the present disclosure.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The proposed systems, methods, algorithms and techniques described herein address the problem of mapping in-store transactions associated with traceable tenders to valid customer profiles. It is assumed that there exists a database containing known and valid customer profiles. The customer profiles may be obtained through various channels, e.g., paid memberships from partner stores, online users with registered profiles, etc. It is noteworthy that the techniques and algorithms described herein utilize a unique identifier of a traceable tender to map in-store transactions to customer profiles. Other details on the traceable tender itself, such as name and address for example, are not explicitly stored. Also, occasionally, a third party may provide supplemental information about a user of a given traceable tender. Given that in-store transactions contribute towards the majority of sales for a brick-and-mortar business, the task of identifying retail store customers of the brick-and-mortar business with high fidelity is fundamental towards any attempt to obtaining a unified view of customers and their transactions.

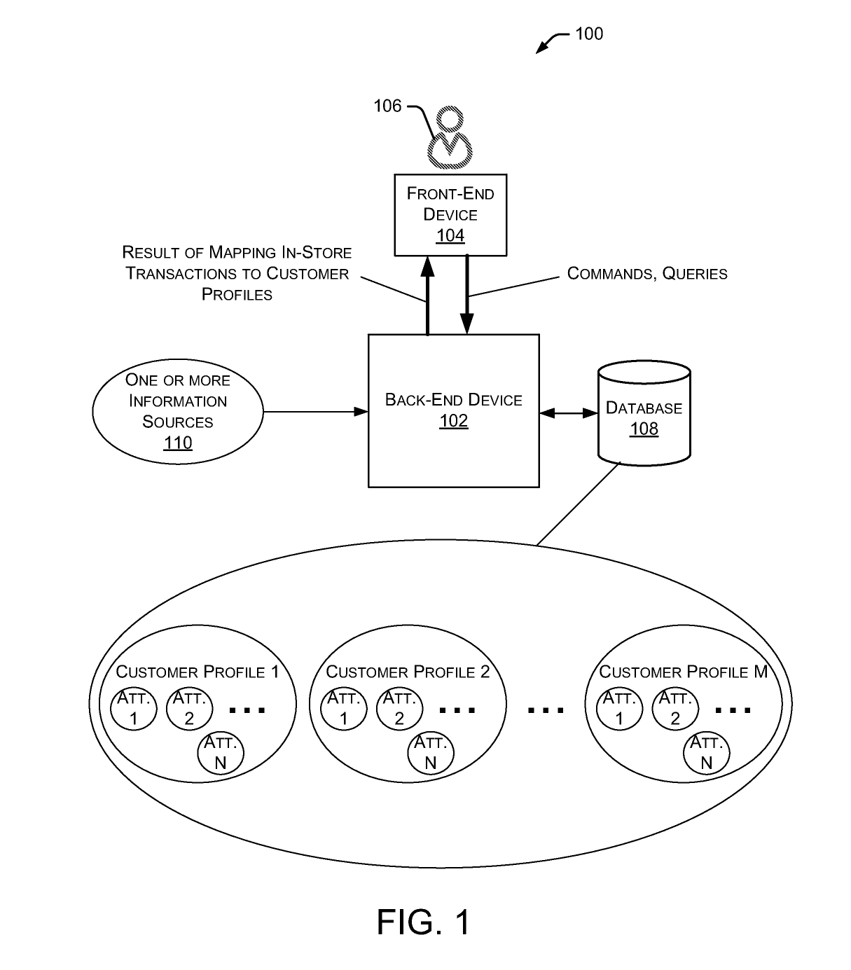

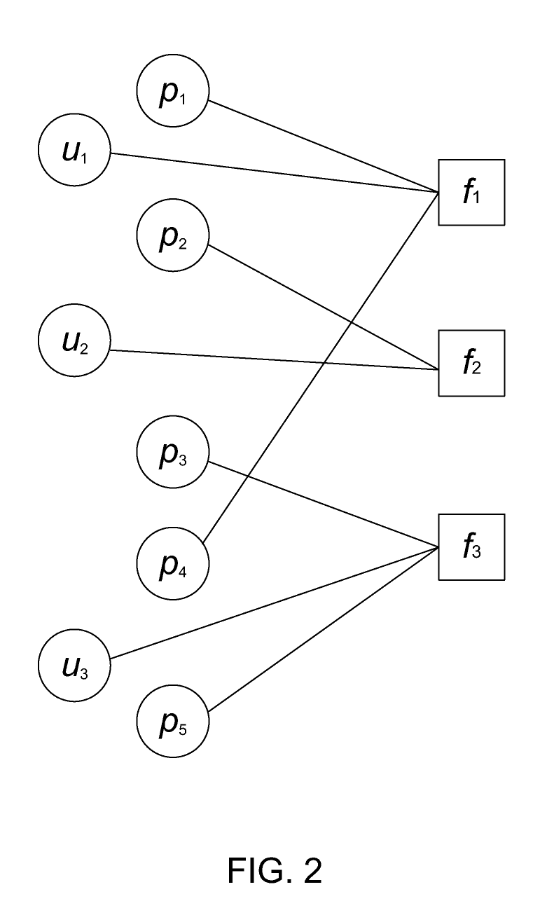

FIG. 1 illustrates an example framework 100 in accordance the present disclosure. FIGS. 2-5B illustrate example implementations of an algorithm in systems and methods in accordance with the present disclosure. The description below refers to FIGS. 1-5B.

Framework 100 includes back-end device 102 and front-end device 104. Back-end device 102 may include one or more processors that execute operations pertaining to algorithms described in the present disclosure. Optionally, database 108 may be communicatively coupled to back-end device 102 to cache or otherwise store some or all of the information and data received, collected and processed by the one or more processors of back-end device 102. In some implementations, database 108 may be an integral part of back-end device 102. Back-end device 102 may be any type of computing device such as, for example, one or more of a desktop computer, a workstation, a server, a mainframe computer, a portable device, etc. Front-end device 104 may be any type of user-interface device including, for example, a combination of one or more of a display panel, a monitor, a keyboard, a computer mouse, a stylus, a keypad, a touch-sensing screen, a voice-command device, or any suitable user-interface device conceivable in the future. Alternatively, front-end device 104 may be any type of computing device such as, for example, a desktop computer, a workstation, a laptop computer, a notebook computer, a tablet, a smartphone, a personal digital assistant, or any suitable handheld device.

Back-end device 102 and front-end device 104 may be integral parts of an apparatus or, alternatively, may be communicatively coupled directly or indirectly through one or more communication devices or one or more networks. In implementations where back-end device 102 and front-end device 104 communicate with one another through one or more networks, the one or more networks may include, for example, a local area network (LAN), a wireless LAN (WLAN), a metropolitan area network (MAN), a wireless MAN (WMAN), a wide area network (WAN), a wireless WAN (WWAN), a personal area network (PAN), a wireless PAN (WPAN) or the Internet. In implementations where back-end device 102 and front-end device 104 communicate with one another through one or more networks including at least one wireless network, the at least one wireless network may be, for example, based on one or more wireless standards such as IEEE 802.11 standards, WiFi, Bluetooth, infrared, WiMax, 2G, 2.5G, 3G, 4G, Long Term Evolution (LTE) and/or future versions and/or derivatives thereof.

User 106, an operator of an e-commerce website, operates front-end device 104 to access back-end device 102. For example, through front-end device 104, user 106 sends commands and/or queries to back-end device 102 to view results of mapping of in-store transactions to customer profiles. In response, back-end device 102 provides a result of mapping of in-store transactions to customer profiles by displaying, e.g., on front-end device 104, one or more in-store customers associated with one or more in-store transactions that are mapped to one or more customer profiles of one or more online customers.

Database 108 maintains a database of a number of valid customer profiles of a number of online customers. As shown in FIG. 1, each customer profile includes a number of types of attributes, e.g., Att. 1, Att. 2 . . . Att. N as shown in FIG. 1, associated with the respective online customer. The types of attributes may include, for example, first name, last name, physical (mailing) address, and one or more traceable tenders of the respective online customer. Optionally, the types of attributes may include additional information related to the online customer such as, for example, e-mail address, phone number, preferences, purchase history, order details, etc.

Other than database 108, back-end device 102 may receive information related to in-store customers and/or online customers from one or more information sources 110. The one or more information sources 110 may include, for example, partner stores, business affiliates, credit bureaus, consumer reporting agencies, etc.

Referring to the example scenario where customer A buys a large flat-screen TV at a retail store operated by business B using a credit card and later logs into the e-commerce website operated by business B, the problem to be solved can be reduced to the following: Given a unique identifier (ID) x associated with a credit card (or any other suitable traceable tender) used in store and a database of valid customer profiles P, how can a single customer profile or multiple customer profiles from P be associated with, or mapped to, the user of x? Each of the customer profiles in P typically includes name and address information that the respective customer provided to the affiliate or e-commerce website, along with unique IDs of credit cards (or one or more other suitable traceable tenders) from past transaction history. With just x available, there is not much that can be done. However, the presence of P makes it possible to leverage some information in P to tag or map x with a customer profile. For illustrative purpose and not limiting the scope of the present disclosure, the term “traceable tender” refers to a credit card in the examples described hereinafter, but may be a debit card or any other suitable traceable tender.

If a credit card x used by a customer in a retail store was also used by a customer with customer profile p in P, then it is reasonable to believe that the user of x is indeed p. However, the task becomes complicated given multiple pieces of competing evidence that do not necessarily agree. Furthermore, there is a need to account for evidence from multiple information sources. Accordingly, the proposed techniques and algorithms use a principled framework to perform probabilistic inference, which is described below.

Let U={u₁, u₂, . . . u_{N}} represent the set of all customers who had in-store transactions associated with them, where uᵢ represents a customer who used the credit card with the unique ID of xᵢ in a retail store. Let P denote the set of all customer profiles known a priori. For every pⱼ in P, relevant details of customer profiles are known, such as last name, first name, physical address and one or more unique IDs pertaining to credit cards used in the past. Here, uᵢ is an unobserved random variable, i.e., uᵢ has an associated customer profile but it is not known to the brick-and-mortar business and/or e-commerce merchant yet. On the other hand, P consists of fully observed variables (customer profiles). It is assumed that the profile pertaining to uᵢ is in P. The goal of probabilistic inference is then to find a distribution over as expressed by equation (1) below. Here the state space of uᵢ is P.

P(uᵢ|P,xᵢ)=P(uᵢ|{customer profiles in P that used xᵢ}) (1)

Notice that if the information present in the intersection of credit card usage is not utilized, the maximum entropy principle will place a uniform distribution over uᵢ, i.e., all customer profiles are equally likely. Also, all nodes in U that do not share a credit card with at least one profile in P are represented a uniform representation over customer profiles in P. Alternatively, all nodes in U that do not share a credit card with some customer profiles in P may be removed from the graph.

Overlap in credit card usage among customer profiles will introduce certain dependencies between variables in the graph. These dependencies can be used to draw a probabilistic graphical model, which then allows for efficient inference algorithms. Here, a factor graph is used to model the dependencies between variables. A factor graph has two kinds of nodes: variable nodes and function nodes. A factor graph is a bipartite graph, in the sense that there are edges only between variable and function nodes, but not between nodes of the same kind Role of a function node is to model the interaction between the variable nodes that connect to the function node. A function node encodes the logic of assimilating evidence from its neighbors and makes meaningful assignments to all the unobserved variable nodes connected to it.

Referring to FIG. 2, the factor graph represents a data set including nodes p₁, p₂, p₃, p₄ and p₅ which correspond to observed variables, e.g., those corresponding to a retail store chain and an e-commerce website where customers are required to register with valid name and address. The nodes u₁, u₂ and u₃ correspond to customers of in-store transactions and they are unobserved because no customer information, e.g., name and address, was obtained or required at the point of sale. Here, a function node is created for every credit card associated with a profile in U. Variables in the factor graph can be observed (elements in P) or unobserved (elements in U). Given a function node fₖ pertaining to a credit card xₖ, all variable nodes (customers) that have used xₖ at least once to complete a transaction are connected.

A function node sends and receives messages from all its neighbors. An outgoing message from a variable node advertises its observed value (or a distribution if unobserved) to the function node. In turn, the function node processes all its incoming messages and “enforces” the most likely distribution to all unobserved nodes connected to it.

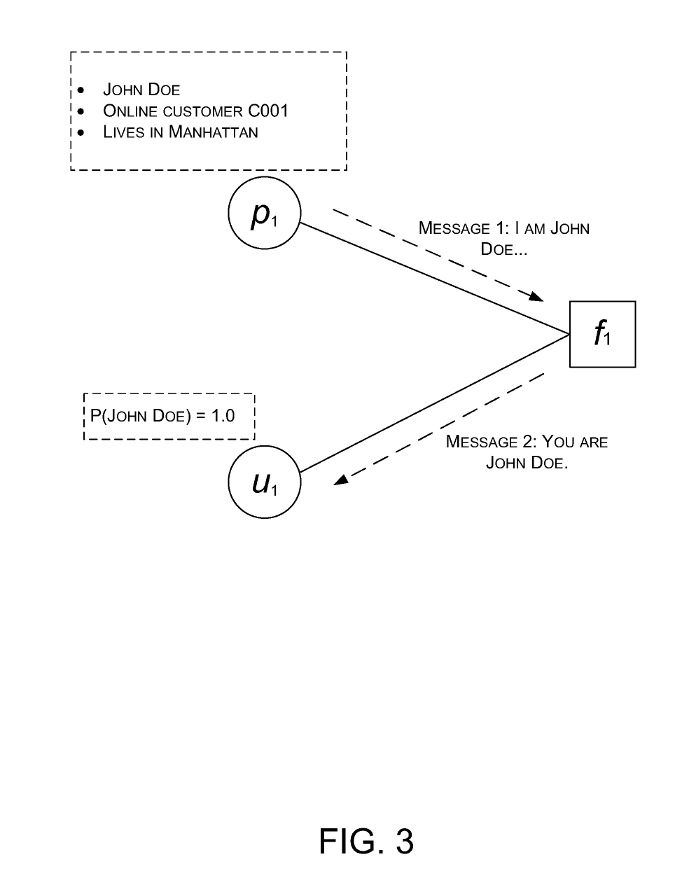

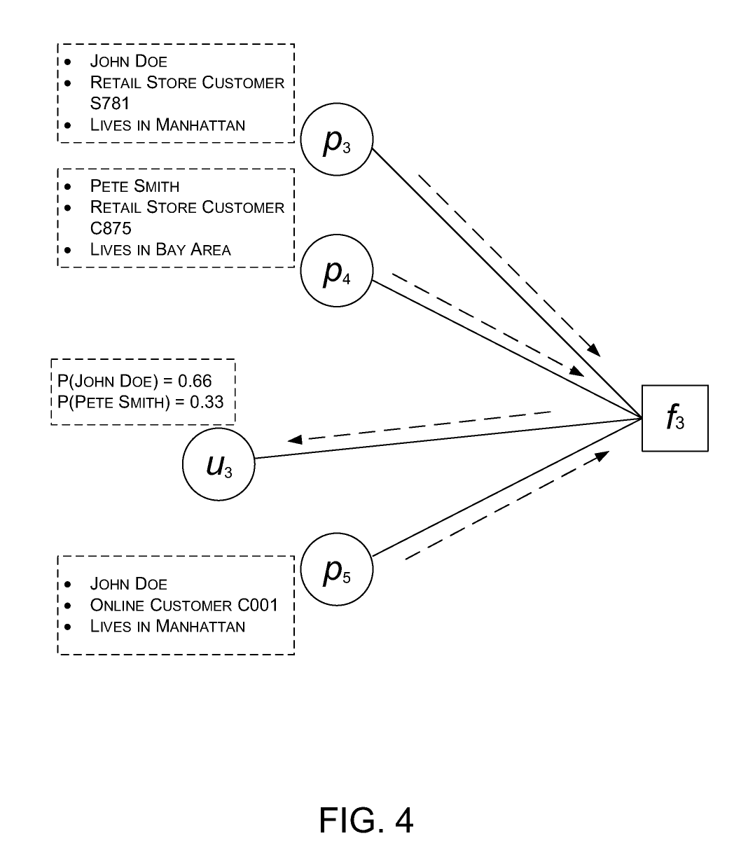

If a function node fₖ is connected to exactly one observed node pi and exactly one unobserved node uₖ, then fₖ while computing P(uₖ|pᵢ) would place all the probability mass on the observed profile, as shown in FIG. 3. As shown in FIG. 3, exactly one observed and exactly one unobserved node are in the factor graph. As there is no competing evidence, the function node f₁ passes the incoming information from the observed variable node p₁ to the unobserved variable node u₁.

If multiple observed nodes are connected to a function node, then fₖ tries to process the information contained in the observed profiles before making an assignment. If the observed profiles are distinct with no name or address similarity, then P(uₖ|pᵢ, p₂, . . . ) is uniform across the observed profiles and zero elsewhere. If the observed profiles have some overlap then the probability mass is spread out based on the overlap, as shown in FIG. 4. As shown in FIG. 4, multiple observed variable nodes p₃, p₄ and p₅ feed evidence to a single unobserved variable node u₃ through a function node f₃. The probability weights shown are examples for illustrative purposes. The function node f₃ figures out that customer profiles C001 and S781 pertain to the same individual and hence places a larger weight on it.

The logic encoded in the function node also analyzes incoming profiles to verify if they constitute a household. This may be accomplished by computing last name and address similarity. In the event a household is identified, a special annotation may be made in the unobserved variable node regarding this observation, and all household members may be assigned equal probability.

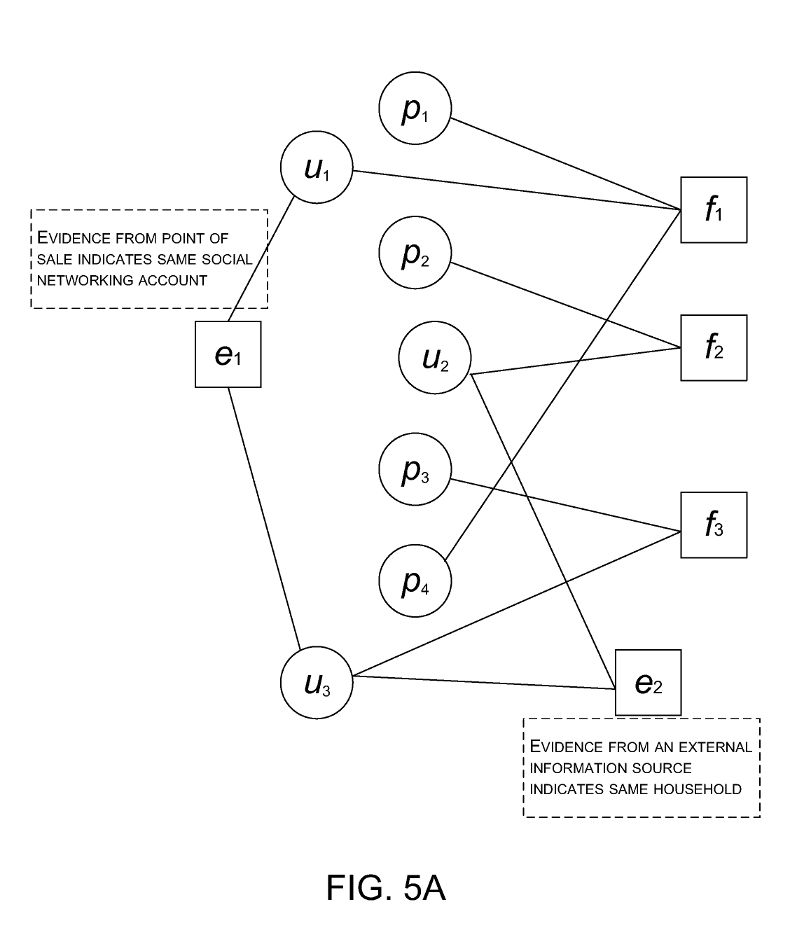

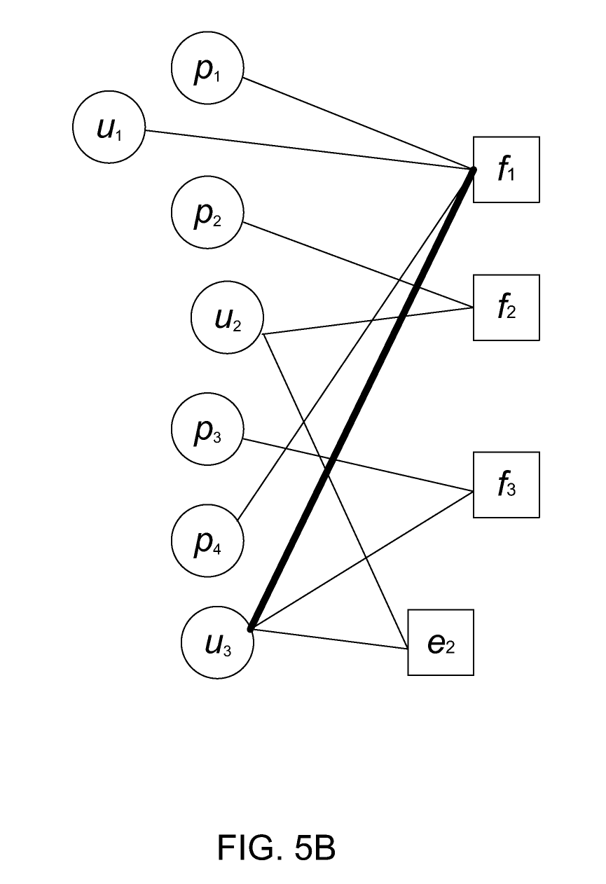

Occasionally, back-end device 102 may receive an indication from the one or more information sources 110 that two in-store transactions (uᵢ's) are strongly related. For example, a third part, e.g., a credit bureau, may indicate that two traceable tenders used in store pertain to the same customer. In such cases the factor graph can be extended to accommodate this evidence by adding a new function node between the unobserved profiles that could be related, as shown in FIG. 5A and FIG. 5B. FIG. 5A shows an example of leveraging evidence about transactions. By connecting unobserved variable nodes that are related, the algorithm can still reason by passing messages. However, the presence of cycles in the graph would require a few iterations before the messages reach a stationary point. A cycle-free graph can still be arrived by folding auxiliary evidence into existing function nodes. As shown in FIG. 5B, the factor graph illustrates fusing the auxiliary evidence shared between u₁ and u₂ into fᵢ. This is bound to increase the complexity of the logic in the function nodes. Given that the factor graph is sparse for most part, this would not be a computational overhead, and has the desirable property of converging in one pass.

Occasionally customers share one or all of phone numbers, e-mail addresses, social media affiliations among others at the point of sale in a retail store. Such information can also be used to connect in-store transactions. At an extreme, where possible and applicable, one can envision leveraging biometric information, e.g., applying evidence from face recognition on images collected at a point of sale terminal. Such auxiliary information may lead to a richly connected graph, thus improving the quality of probabilistic inference.

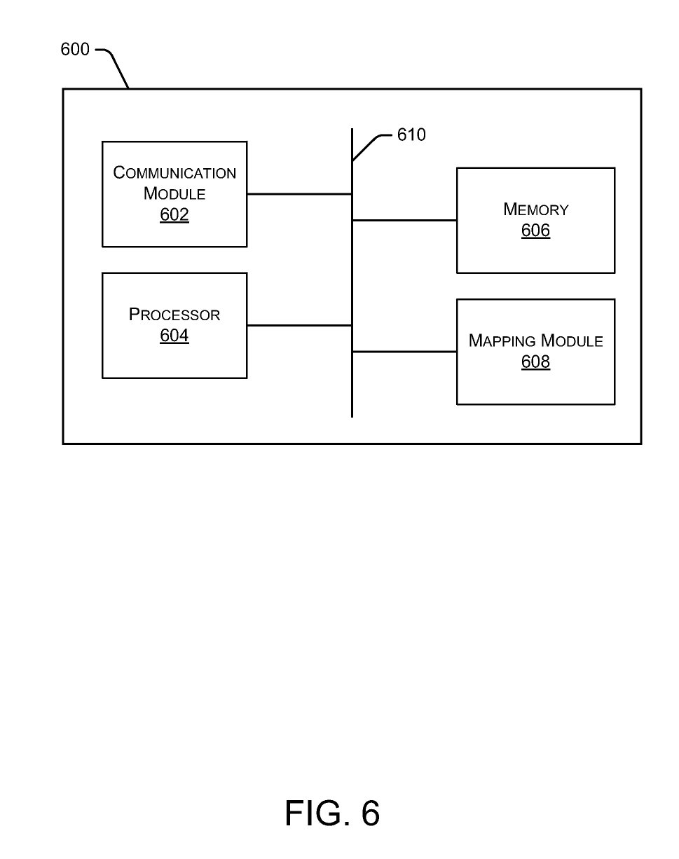

FIG. 6 illustrates an example computing device 600 configured to implement systems and methods in accordance with the present disclosure. Computing device 600 performs various functions related to the operation of back-end device 102, as discussed herein. In some embodiments, back-end device 102 includes multiple ones of computing device 600 that cooperatively implement the functions described herein. Computing device 600 includes a communication module 602, a processor 604, and a memory 606. Communication module 602 allows computing device 600 to communicate with other systems, such as communication networks, other servers, front-end device 104, etc. In some embodiments, computing device 600 includes more than one processor 604. For simplicity, however, the description hereinafter refers to the example in which computing device 600 includes one processor 604.

Processor 604 executes one or more sets instructions to implement the functionality provided by computing device 600. Memory 606 stores those one or more sets of instructions executable by processor 604 as well as other data used by processor 604 and other modules contained in computing device 600. Computing device 600 also includes a mapping module 608, which maps in-store transactions to customer profiles as described herein. For illustrative purposes, mapping module 608 is shown in FIG. 6 as an individual module separate from processor 604. In some implementations, however, mapping module 608 may be an integral part of processor 604. A data communication bus 610 allows the various modules and components of computing device 600 to communicate with each other.

Memory 606 may store data and one or more sets of instructions. Processor 604 may execute the one or more sets of instructions and control communication module 602 and mapping module 608. Processor 604 may, alone or in conjunction with mapping module 608, carry out processes 700 and 800, as described below, and any variations thereof.

For example, processor 604 may control mapping module 608 to receive, e.g., from database 108, information of a number of customer profiles of a number of online customers. Each of the customer profiles may include a number of attributes associated with a respective one of the online customers. The attributes may include an identifier of a traceable tender. Processor 604 may also receive information of a number of in-store transactions by a number of in-store customers. The information of each of the in-store transactions may include an identifier of a traceable tender used by the respective in-store customer in one or more in-store purchases. For at least one of the in-store customers, processor 604 may map one or more of the customer profiles of online customers to the at least one of the in-store customers by matching the identifier of the traceable tender associated with the at least one of the in-store customers to the respective identifier of a traceable tender associated with each of the one or more of the customer profiles.

As another example, processor 604 may receive, e.g., from database 108, information of a number of customer profiles of a number of online customers. Each of the customer profiles may include a number of types of attributes associated with a respective one of the online customers. The types of attributes may include a first type of attribute. Processor 604 may also receive information of a number of in-store transactions by a number of in-store customers. The information of each of the in-store transactions may include the first type of attribute associated with the respective in-store customer. Processor 604 may further map, for at least one of the in-store customers, one or more of the customer profiles of online customers to the at least one of the in-store customers based at least in part on the first type of attribute.

As yet another example, processor 604 may access a database, e.g., database 108, to obtain information of a number of customer profiles of a number of online customers. Each of the customer profiles may include a number of types of attributes associated with a respective one of the online customers. The types of attributes may include a first type of attribute. Processor 604 may also receive information of a first in-store transaction by a first in-store customer. The information of the first in-store transaction may include the first type of attribute associated with the first in-store customer. Processor 604 may further map one or more of the customer profiles of online customers to the first in-store customer based at least in part on the first type of attribute.

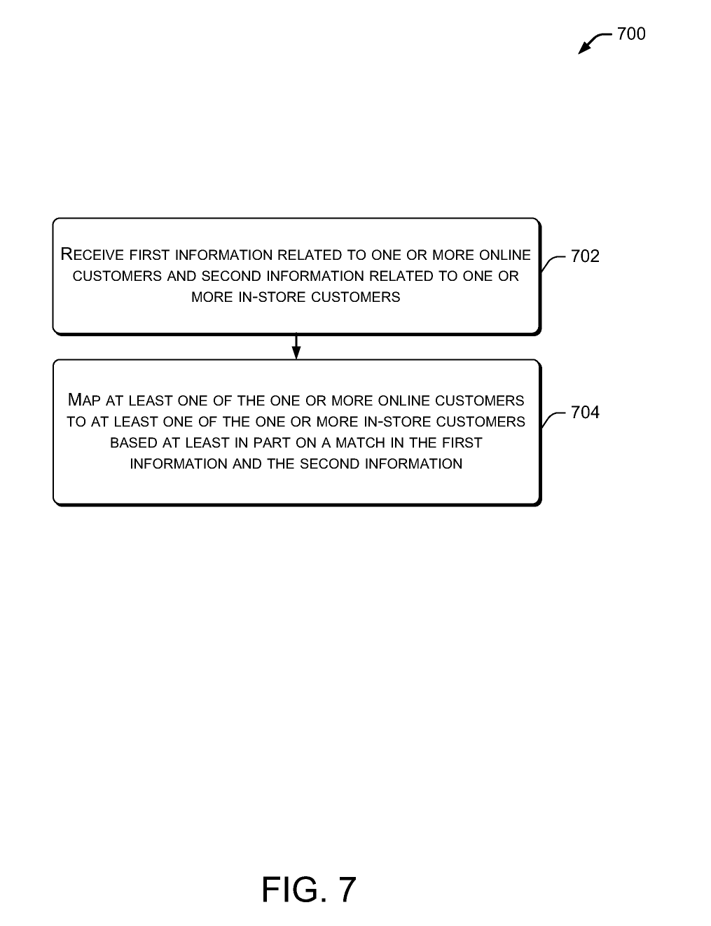

FIG. 7 illustrates an example process 700 for clustering of customers using transaction patterns. Example process 700 includes one or more operations, actions, or functions as illustrated by one or more of blocks 702 and 704. Although illustrated as discrete blocks, various blocks may be divided into additional blocks, combined into fewer blocks, or eliminated, depending on the desired implementation. Process 700 may be implemented by one or more processors including, for example, one or more processors of back-end device 102 and processor 604 of computing device 600. Moreover, some or all of the operations of process 700 may be carried out by mapping module 608 under the control of processor 604. For illustrative purposes, the operations described below are performed by one or more processors of computing device 600 as shown in FIG. 6.

At 702, processor 604 of computing device 600 may receive first information related to one or more online customers and second information related to one or more in-store customers. In one embodiment, the first information may include information of customer profiles of the one or more online customers. Each of the customer profiles may include a number of types of attributes including a first type of attribute. In one embodiment, the second information may include information of in-store transactions by the one or more in-store customers. The information of each of the in-store transactions may include the first type of attribute of the types of attributes.

At 704, processor 604 of computing device 600 may map at least one of the one or more online customers to at least one of the one or more in-store customers based at least in part on a match in the first information and the second information. In one embodiment, the processor 604 may map at least one of the one or more online customers to at least one of the one or more in-store customers based on a match in the first type of attribute.

To illustrate, consider an example where user 106 queries back-end device 102 to map in-store transactions to customer profiles. In this example, processor 604 of computing device 600 can retrieve, from database 108, information of a number of customer profiles of a number of online customers. Processor 604 also receives information of a number of in-store transactions by a number of in-store customers. Then, processor 604 maps one or more of the customer profiles of online customers to at least one of the in-store customers based at least in part on the first type of attribute. The results of mapping can thus be displayed to user 106 via front-end device 104.

In one embodiment, the types of attributes associated with each of the customer profiles may include a last name, a first name, an address, and one or more identifiers of one or more traceable tenders.

In one embodiment, the first type of attribute may include the one or more identifiers of one or more traceable tenders.

In one embodiment, each of the one or more traceable tenders may be a credit card or a debit card.

In one embodiment, when performing the mapping operation, processor 604 of computing device 600 may map the one or more of the customer profiles of online customers to the at least one of the in-store customers by matching the first type of attribute associated with the at least one of the in-store customers to the respective first type of attribute associated with each of the one or more of the customer profiles.

Alternatively or additionally, when performing the mapping operation, processor 604 of computing device 600 may map the one or more of the customer profiles of online customers to the at least one of the in-store customers based at least in part on the first type of attribute using probabilistic inference.

Alternatively or additionally, when performing the mapping operation, processor 604 of computing device 600 may map more than one of the customer profiles of online customers to the at least one of the in-store customers based at least in part on the first type of attribute using weights associated with the more than one of the customer profiles. The weights may be determined, e.g., by processor 604 of computing device 600, based on one or more similarities between the types of attributes associated with the more than one of the customer profiles.

In one embodiment, process 700 may include additional operations as follows. Processor 604 of computing device 600 may receive information indicating that a first in-store transaction and a second in-store transaction of the in-store transactions are related. Moreover, processor 604 of computing device 600 may further perform either of: (1) mapping at least one of the customer profiles mapped to a first in-store customer associated with the first in-store transaction to a second in-store customer associated with the second in-store transaction; or (2) mapping at least one of the customer profiles mapped to the second in-store customer associated with the second in-store transaction to the first in-store customer associated with the first in-store transaction.

In another embodiment, process 700 may include additional operations as follows. Processor 604 of computing device 600 may identify one or more similarities between one or more of the types of attributes associated with a first customer profile of the customer profiles and corresponding one or more of the types of attributes associated with at least a second customer profile of the customer profiles. Furthermore, processor 604 of computing device 600 may annotate the first and the second customer profiles to indicate that online customers associated with the first and the second customer profiles are related.

In yet another embodiment, process 700 may include additional operations as follows: Processor 604 of computing device 600 may receive, from a point of sale, first information related to a first in-store customer of the in-store customers. Processor 604 of computing device 600 may then identify one or more similarities between a second type of attribute in the first information and the second type of attribute associated with at least one customer profile of the customer profiles. Processor 604 of computing device 600 may further map the at least one customer profile of the customer profiles to the first in-store customer responsive to the identifying.

In one embodiment, the second type of attribute may be biometric information.

In one embodiment, according to process 700, processor 604 of computing device 600 may establish a graphical model that represents the received first and second information and one or more correlations between the one or more online customers and the one or more in-store customers. The graphical model may include variable nodes representative of the one or more online customers and the one or more in-store customers. The graphical model may further include functional nodes representative of at least a type of attribute associated with the one or more online customers and the one or more in-store customers. According to the graphical model, there is a match between a first online customer of the one or more online customers and a first in-store customer of the one or more in-store customers when at least one of the functional nodes is connected to the first online customer and the first in-store customer.

In one embodiment, according to process 700, processor 604 of computing device 600 may further receive additional information related to the one or more online customers and the one or more in-store customers. Processor 604 may then expand the graphical model using the additional information.

In one embodiment, the additional information may include information received from a social media (e.g., Facebook, MySpace, Twitter and the like), a third-party data provider (e.g., credit reporting agencies such as Experian, Equifax, Transunion, etc.), or both types of sources.

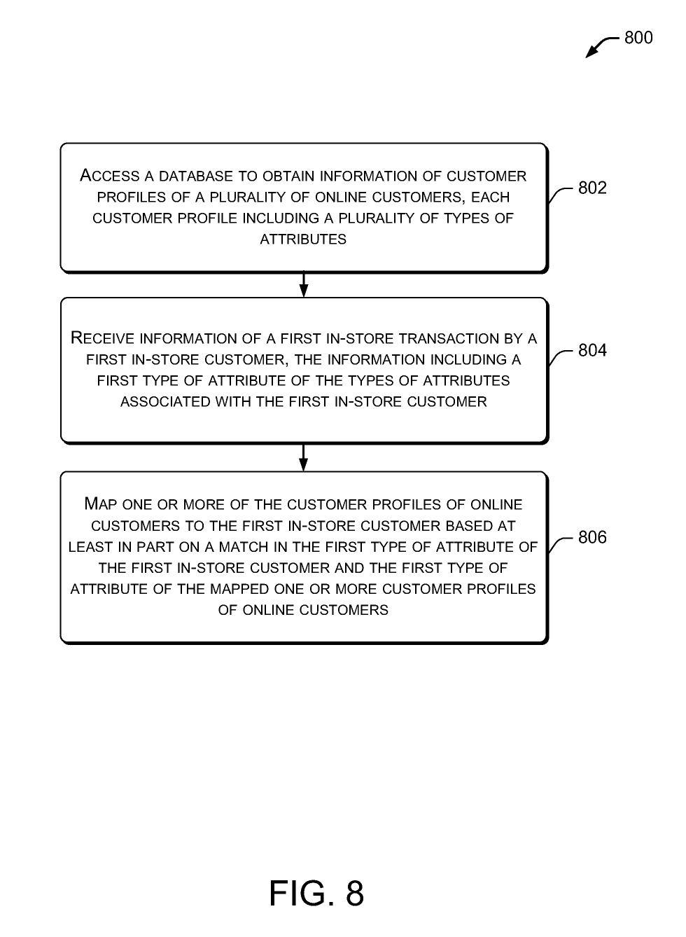

FIG. 8 illustrates an example process 800 for clustering of customers using transaction patterns. Example process 800 includes one or more operations, actions, or functions as illustrated by one or more of blocks 802, 804 and 806. Although illustrated as discrete blocks, various blocks may be divided into additional blocks, combined into fewer blocks, or eliminated, depending on the desired implementation. Process 800 may be implemented by one or more processors including, for example, one or more processors of back-end device 102 and processor 604 of computing device 600. Moreover, some or all of the operations of process 800 may be carried out by mapping module 608 under the control of processor 604. For illustrative purposes, the operations described below are performed by processor 604 of computing device 600 as shown in FIG. 6.

At 802, processor 604 of computing device 600 may access a database, e.g., database 108, to obtain information of a number of customer profiles of a number of online customers. Each of the customer profiles may include a number of types of attributes associated with a respective one of the online customers. The types of attributes may include a first type of attribute.

At 804, processor 604 of computing device 600 may receive information of a first in-store transaction by a first in-store customer. The information of the first in-store transaction may include the first type of attribute associated with the first in-store customer.

At 806, processor 604 of computing device 600 may map one or more of the customer profiles of online customers to the first in-store customer based at least in part on a match in the first type of attribute of the first in-store customer and the first type of attribute of the mapped one or more customer profiles of online customers.

As an example, processor 604 of computing device 600 can access database 108 to obtain information of a number of customer profiles of a number of online customers. Processor 604 then receives information of a first in-store transaction by a first in-store customer. Next, processor 604 maps one or more of the customer profiles of online customers to the first in-store customer based at least in part on the first type of attribute. The results of mapping can thus be displayed to user 106 via front-end device 104.

In one embodiment, the types of attributes associated with each of the customer profiles may include a last name, a first name, an address, and one or more identifiers of one or more traceable tenders. The first type of attribute may include the one or more identifiers of one or more traceable tenders.

In one embodiment, each of the one or more traceable tenders may be a credit card or a debit card.

In one embodiment, when mapping, processor 604 of computing device 600 may map the one or more of the customer profiles of online customers to the first in-store customer by matching the first type of attribute associated with the first in-store customer to the respective first type of attribute associated with each of the one or more of the customer profiles.

In one embodiment, when mapping, processor 604 of computing device 600 may map more than one of the customer profiles of online customers to the first in-store customer based at least in part on the first type of attribute using weights associated with the more than one of the customer profiles. The weights may be determined, e.g., by processor 604 of computing device 600, based on one or more similarities between the types of attributes associated with the more than one of the customer profiles.

In one embodiment, process 800 may include additional operations as follows. Processor 604 of computing device 600 may receive information indicating that the first in-store transaction and a second in-store transaction of the in-store transactions are related. Processor 604 of computing device 600 may further perform either of: (1) mapping at least one of the customer profiles mapped to the first in-store customer associated with the first in-store transaction to a second in-store customer associated with the second in-store transaction; or (2) mapping at least one of the customer profiles mapped to the second in-store customer associated with the second in-store transaction to the first in-store customer associated with the first in-store transaction.

In another embodiment, process 800 may include additional operations as follows. Processor 604 of computing device 600 may identify one or more similarities between one or more of the types of attributes associated with a first customer profile of the customer profiles and corresponding one or more of the types of attributes associated with at least a second customer profile of the customer profiles. Processor 604 of computing device 600 may further annotate the first and the second customer profiles to indicate that online customers associated with the first and the second customer profiles are related.

In yet another embodiment, process 800 may include additional operations as follows. Processor 604 of computing device 600 may receive, from a point of sale, first information related to a first in-store customer of the in-store customers. Processor 604 of computing device 600 may the identify one or more similarities between a second type of attribute in the first information and the second type of attribute associated with at least one customer profile of the customer profiles. Processor 604 of computing device 600 may further map the at least one customer profile of the customer profiles to the first in-store customer responsive to the identifying. The second type of attribute may be biometric information.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope in accordance with the present disclosure.

1. A method comprising:
receiving, by one or more processors, first information related to one or more online customers and second information related to one or more in-store customers; and
mapping at least one of the one or more online customers to at least one of the one or more in-store customers based at least in part on a match in the first information and the second information.

2. The method of claim 1, wherein the first information includes information of customer profiles of the one or more online customers, each of the customer profiles including a plurality of types of attributes including a first type of attribute, and wherein the second information includes information of in-store transactions by the one or more in-store customers, the information of each of the in-store transactions including the first type of attribute of the types of attributes.

3. The method of claim 2, wherein the mapping comprises mapping at least one of the one or more online customers to at least one of the one or more in-store customers based on a match in the first type of attribute.

4. The method of claim 2, wherein the types of attributes associated with each of the customer profiles comprise a last name, a first name, an address, and one or more identifiers of one or more traceable tenders.

5. The method of claim 4, wherein the first type of attribute comprises the one or more identifiers of one or more traceable tenders.

6. The method of claim 4, wherein each of the one or more traceable tenders comprises a credit card or a debit card.

7. The method of claim 2, wherein the mapping comprises mapping the one or more of the customer profiles of online customers to the at least one of the in-store customers by matching the first type of attribute associated with the at least one of the in-store customers to the respective first type of attribute associated with each of the one or more of the customer profiles.

8. The method of claim 2, wherein the mapping comprises mapping the one or more of the customer profiles of online customers to the at least one of the in-store customers based at least in part on the first type of attribute using probabilistic inference.

9. The method of claim 2, wherein the mapping comprises mapping more than one of the customer profiles of online customers to the at least one of the in-store customers based at least in part on the first type of attribute using weights associated with the more than one of the customer profiles, and wherein the weights are determined based on one or more similarities between the types of attributes associated with the more than one of the customer profiles.

10. The method of claim 2, further comprising:
receiving, by the one or more processors, information indicating that a first in-store transaction and a second in-store transaction of the in-store transactions are related; and
performing either of:
mapping at least one of the customer profiles mapped to a first in-store customer associated with the first in-store transaction to a second in-store customer associated with the second in-store transaction; or
mapping at least one of the customer profiles mapped to the second in-store customer associated with the second in-store transaction to the first in-store customer associated with the first in-store transaction.

11. The method of claim 2, further comprising:
identifying, by the one or more processors, one or more similarities between one or more of the types of attributes associated with a first customer profile of the customer profiles and corresponding one or more of the types of attributes associated with at least a second customer profile of the customer profiles; and
annotating the first and the second customer profiles to indicate that online customers associated with the first and the second customer profiles are related.

12. The method of claim 2, further comprising:
receiving, by the one or more processors from a point of sale, first information related to a first in-store customer of the in-store customers;
identifying one or more similarities between a second type of attribute in the first information and the second type of attribute associated with at least one customer profile of the customer profiles; and
mapping the at least one customer profile of the customer profiles to the first in-store customer responsive to the identifying.

13. The method of claim 12, wherein the second type of attribute comprises biometric information.

14. A method comprising:
accessing, by one or more processors, a database to obtain information of customer profiles of a plurality of online customers, each of the customer profiles including a plurality of types of attributes;
receiving information of a first in-store transaction by a first in-store customer, the information of the first in-store transaction including a first type of attribute of the types of attributes associated with the first in-store customer; and
mapping one or more of the customer profiles of online customers to the first in-store customer based at least in part on a match in the first type of attribute of the first in-store customer and the first type of attribute of the mapped one or more customer profiles of online customers.

15. The method of claim 14, wherein the types of attributes associated with each of the customer profiles comprise a last name, a first name, an address, and one or more identifiers of one or more traceable tenders, and wherein the first type of attribute comprises the one or more identifiers of one or more traceable tenders.

16. The method of claim 15, wherein each of the one or more traceable tenders comprises a credit card or a debit card.

17. The method of claim 14, wherein the mapping comprises mapping the one or more of the customer profiles of online customers to the first in-store customer by matching the first type of attribute associated with the first in-store customer to the respective first type of attribute associated with each of the one or more of the customer profiles.

18. The method of claim 14, wherein the mapping comprises mapping more than one of the customer profiles of online customers to the first in-store customer based at least in part on the first type of attribute using weights associated with the more than one of the customer profiles, and wherein the weights are determined based on one or more similarities between the types of attributes associated with the more than one of the customer profiles.

19. The method of claim 14, further comprising:
receiving, by the one or more processors, information indicating that the first in-store transaction and a second in-store transaction of the in-store transactions are related; and
performing either of:
mapping at least one of the customer profiles mapped to the first in-store customer associated with the first in-store transaction to a second in-store customer associated with the second in-store transaction; or
mapping at least one of the customer profiles mapped to the second in-store customer associated with the second in-store transaction to the first in-store customer associated with the first in-store transaction.

20. The method of claim 14, further comprising:
identifying, by the one or more processors, one or more similarities between one or more of the types of attributes associated with a first customer profile of the customer profiles and corresponding one or more of the types of attributes associated with at least a second customer profile of the customer profiles; and
annotating the first and the second customer profiles to indicate that online customers associated with the first and the second customer profiles are related.

21. The method of claim 14, further comprising:
receiving, by the one or more processors from a point of sale, first information related to a first in-store customer of the in-store customers;
identifying one or more similarities between a second type of attribute in the first information and the second type of attribute associated with at least one customer profile of the customer profiles; and
mapping the at least one customer profile of the customer profiles to the first in-store customer responsive to the identifying,
wherein the second type of attribute comprises biometric information.

22. An apparatus comprising:
a memory configured to store data and one or more sets of instructions; and
one or more processors coupled to the memory, the one or more processors configured to execute the one or more sets of instructions and perform operations comprising:
receiving, by one or more processors, information of a plurality of customer profiles of a plurality of online customers, each of the customer profiles including a plurality of attributes associated with a respective one of the online customers, the attributes including an identifier of a traceable tender;
receiving information of a plurality of in-store transactions by a plurality of in-store customers, the information of each of the in-store transactions including an identifier of a traceable tender used by the respective in-store customer in one or more in-store purchases; and
mapping, for at least one of the in-store customers, one or more of the customer profiles of online customers to the at least one of the in-store customers by matching the identifier of the traceable tender associated with the at least one of the in-store customers to the respective identifier of a traceable tender associated with each of the one or more of the customer profiles.
